(19) United States
(12) Patent Application Publication
(10) Pub. No.: US 2014/0268813 A1
(43) Pub. Date: Sep. 18, 2014

(54) LIGHTING DEVICE WITH VIRTUAL LIGHT SOURCE

(71) Applicant: LIGHTEL TECHNOLOGIES INC., Renton, WA (US)

(72) Inventors: CHIA-YIU MAA, BELLEVUE, WA (US); PAI-SHENG SHEN, BELLEVUE, WA (US); CHUNTE YU, BELLEVUE, WA (US); GE ZHOU, RENTON, WA (US); CHING-FENG LIN, TAIPEI (TW)

(73) Assignee: LIGHTEL TECHNOLOGIES INC., Renton, WA (US)

(21) Appl. No.: 13/842,315

(22) Filed: Mar. 15, 2013

(51) Int. Cl. F21V 7/04; F21V 7/06; F21V 7/08; F21V 13/04

(52) U.S. Cl. CPC F21V 7/04; F21V 13/04; F21V 7/06; F21V 7/08
USPC 362/308; 362/307

(57) ABSTRACT

A lighting device includes a light source and an enclosure enclosing the light source wherein a portion of the enclosure has a focus-forming curvature such that when the light from the light source is reflected off the enclosure element the reflected light intersects at the focus of the curvature and creates a virtual light source at the focus. A reflective coating or a reflective material may be applied to the enclosure, or a ball lens may be used around the light source, to increase the intensity of the reflected light and of the virtual light source. A diffuser may be used to change the size and shape of the virtual light source.

### BACKGROUND OF THE INVENTION

1. Field of the Invention

The invention relates to lighting devices and more particularly to a lighting device, in which the light emitting from its light source is reflected off an enclosure element to form a virtual light source.

2. Description of the Related Art

Lighting devices are classified into two categories, direct lit or indirect lit, depending on whether the illumination of the lighting devices comes directly from the light source of the devices or indirectly from a reflector. Most lighting devices, such as candle, incandescent, halogen, and LED lamps are direct-lit lighting devices, with or without an optical filter or lens. Fluorescent lamps are also considered direct-lit lighting devices since the light comes directly from the lighting surface of the fluorescent lamps. In contrast, indirect-lit lighting devices provide illumination by using a reflecting mechanism to reflect the light from the light source of the lighting device off a reflecting mechanism, often in a direction opposite to the original lighting direction of the light source.

The present invention combines at least one light source and one enclosure element wherein at least one portion of the enclosure element has a focus-forming curvature such that when the light from the light source is reflected off the enclosure element the reflected light intersects at the focus of the curvature and creates a virtual light source at the focus. The virtual light source which is created off the reflected light becomes a new direct-lit light source.

### SUMMARY OF THE INVENTION

The present invention combines at least one light source and one enclosure element whereas at least one portion of the enclosure element. The present invention is characterized by that at least one portion of the enclosure element takes on the geometric shape of a focus-forming curvature so that when the light from the light source is reflected off the focus-forming portion of the enclosure element, the reflected light intersects at the focus of the geometric shape and creates a virtual light source at that focus. This virtual light source of the lighting device becomes the new light source for illumination, rather than the original light source.

Two examples of focus-forming geometric shape for forming virtual light source are ellipsoid and paraboloid. With an ellipsoid, the original light source of the lighting device is placed at one of the two focuses of an ellipsoid and thus creates the virtual light source at the other focus of the ellipsoid. With a paraboloid, multiple original light sources are placed at any positions on the open end of the paraboloid, and the reflected light intersects at the focus of the paraboloid.

In one aspect of the present invention, an optical lens is placed between the light source and the focus of the focus-forming curvature of the enclosure element such that the optical lens changes the lighting angle of the light source and subsequently changes the shape and size of the intersection of the light reflected off the focus-forming curvature. In this case, the reflected light intersects at a focus region, rather than a focus point, and the size and shape of the focus region is determined by the design of the optical lens.

One type of optical lens that is used for changing the shape and size of the intersection region of the reflected light is a diffuser lens. A diffuser lens has the effect of widening the lighting angle of the original light source and results in extending the intersection region of the reflected light from the focus of the focus-forming curvature of the enclosure element toward the light source.

In another aspect of the present invention, a reflective means is used on the focus-forming curvature of the enclosure element for increasing the light reflection off the enclosure element and subsequently enhancing the intensity of light that intersects at the focus. In one embodiment, the reflective means is implemented via the application of a reflective coating on the portion of the enclosure element with the focus-forming curvature. In another embodiment, the reflective means is implemented by using a reflective material to fabricate the portion of the enclosure element with the focus-forming curvature. In yet another embodiment, the reflective means is implemented by placing a curved mirror adjacent to the portion of the enclosure element with the focus-forming curvature for light reflection.

In another aspect of the present invention, a reflective means is placed at the focus of the focus-forming curvature of the enclosure element to redirect the reflected light that intersects at the focus. In one embodiment, the reflective means is implemented by a mirror ball for creating a uniform reflecting effect. In another embodiment, the reflective means is implemented via a reflector of a particular shape and pattern so as to create a non-uniform reflecting effect.

In another aspect of the present invention, a light collecting means is placed between the light source and the enclosure element such that the light from the light sources is collected by the light collecting means and redirected toward the focus-forming curvature with the effect of increasing the intensity of light that intersects at the focus of the curvature. One embodiment of the light collecting means is a ball lens. By covering the light source with a ball lens inside a paraboloidal enclosure element, the light from the light source will be redirected in the direction that is parallel to the axis of the paraboloid, thus increasing the amount of light that will be reflected off the enclosure element and intersect at the focus of the paraboloid.

Another embodiment of the light collecting means is to use a paraboloidal reflector behind the light source such that any portion of the light emitting away from the focus of the focus-forming curvature is collected and redirected by the paraboloidal reflector toward the virtual light source.

The present invention differs from the prior art in that it is neither direct-lit nor indirect-lit. Rather, it uses a portion of the enclosure element with a focus-forming curvature such that the light emitting from the original light source and reflected off the enclosure intersects at or around the focus of the curvature and the intersection of the reflected light becomes the new virtual light source of the lighting device.

The claims and advantages will be more readily appreciated as the same becomes better understood by reference to the following detailed description and the accompanying drawings showing exemplary embodiments, in which like reference symbols designate like parts. For clarity, various parts of the embodiments in the drawings are not drawn to scale.

### BRIEF DESCRIPTION OF THE DRAWINGS

FIG. 1 schematically depicts an embodiment of the present invention wherein a light source is placed at one focus of an ellipsoidal enclosure and a virtual light source is created at the other focus of the corresponding ellipsoid.

FIG. 2 schematically depicts an embodiment of the present invention wherein multiple light sources are placed at the open end of a paraboloidal enclosure and a virtual light source is created at the focus of the corresponding paraboloid.

FIG. 3 schematically depicts an embodiment of the present invention wherein a light source is placed at one focus of an ellipsoid, a diffuser lens is placed between the light source and the other focus of the ellipsoid, and a virtual light source is created at the other focus of the ellipsoid extending toward the light source.

FIG. 4 schematically depicts an embodiment of the present invention wherein a reflective means is used on the focus-forming curvature of the enclosure element for increasing the light reflection off the enclosure element.

FIG. 5 schematically depicts an embodiment of the present invention wherein a reflective means is placed at the focus of the focus-forming curvature of the enclosure element to redirect the reflected light that intersects at the focus.

FIG. 6 schematically depicts an embodiment of the present invention wherein the light source is covered with a ball lens inside a paraboloidal enclosure element for collecting and redirecting the light in the direction parallel to the central axis of the paraboloid with the effect of increasing the intensity of reflected light that intersects at the focus of the paraboloid.

FIG. 7 schematically depicts an embodiment of the present invention wherein the light source has 360 degree lighting angle and a paraboloidal reflector is placed behind the light source for collecting and redirecting the light in the direction parallel to the central axis of the paraboloid and toward the focus forming curvature with the effect of increasing the intensity of reflected light that intersects at the focus of the paraboloid.

### DETAILED DESCRIPTION OF THE INVENTION

Various implementations of the present invention and related inventive concepts are described below. It should be acknowledged, however, that the present invention is not limited to any particular manner of implementation, and that the various embodiments explicitly discussed herein are primarily for purposes of illustration. For example, the various concepts discussed herein may be suitably implemented in a variety of luminaires having different form factors and light output.

FIG. 1 illustrates one non-limiting example of a lighting device according to one embodiment of the present invention. The lighting device 100 includes a light source 120 and an ellipsoidal enclosure element 110. The light source 120 is placed at one focus of the corresponding ellipsoid. The light 130A and 130B emitted from the light source 120 partially passes though the enclosure element 110 and partially reflects off the enclosure element 110. The partially reflected light 140A and 140B intersects at the other focus 150 of the ellipsoid due to the nature of the ellipsoid. The light intersecting at the other focus 150 becomes a virtual light source.

FIG. 2 illustrates another non-limiting example of a lighting device according to one embodiment of the present invention. The lighting device 200 includes multiple light sources 220A and 220B and a paraboloidal enclosure element 210. The light 230A and 230B emitted from the light sources 220A and 220B parallel to the axis 211 of the corresponding paraboloid partially passes through the enclosure element 210 and partially reflects off the enclosure element 210. The partially reflected light 240A and 240B intersects at the focus 250 of the paraboloid due to the nature of a paraboloid. The light intersecting at the other focus 250 becomes a virtual light source. It is noted that the paraboloid is an “elliptic paraboloid” as opposed to a “hyperbolic paraboloid”.

FIG. 3 illustrates another embodiment of the present invention. The lighting device 300 includes a light source 320, an ellipsoidal enclosure element 310, and a diffuser lens 360. The light source 320 is placed at one focus of the ellipsoid. When there is no diffuser lens 360, the light 330A and 330B emitted from the light source 320 partially passes though the enclosure element 310 and partially reflects off the enclosure element 310. The partially reflected light 340A and 340B intersects at the other focus 350 of the ellipsoid due to the nature of the ellipsoid. When a diffuser lens 360 is placed over the light source, the light 330A and 330B from the light source is widened by the diffuser lens 360 to become 331A and 331B. The partially reflected light 341A and 341B of the light 331A and 331B now intersects at an area 351, which starts from the focus 350 and extends toward the light source. The region 351 where the reflected light intersects becomes a virtual light source.

FIG. 4 illustrates another embodiment of the present invention. The lighting device 400 includes a light source 420, an ellipsoidal enclosure element 410, and a reflective element 411A and 411B. The light source 420 is placed at one focus of the ellipsoid. The light 430A and 430B emitted from the light source 420 is completely reflected off the reflective means 430A ad 430B, and the reflected light 440A and 440B has the full intensity of the 430A and 430B. As a result, the reflected light that intersects at the other focus 450 of the ellipsoid has a higher intensity, thus creating a brighter virtual light source at the focus 450.

FIG. 5 illustrates another embodiment of the present invention. The lighting device 500 includes a light source 520, an ellipsoidal enclosure element 510, and a reflective means 550. The light source 520 is placed at one focus of the ellipsoid and the reflective means 550 is placed at the other focus of ellipsoid. The light 530A and 530B emitted from the light source 520 partially passes through the enclosure element 510 and partially reflects off the enclosure element 510. The reflected light 540A and 540B intersects at the other focus of the ellipsoid, which is where the reflective means 550 is positioned. So the reflected light 540A and 540B is further reflected to become 550A and 550B. The reflective means 550 becomes a reflective light source and it reflects light in the direction opposite to the light direction of the light source 520.

FIG. 6 illustrates another embodiment of the present invention. The lighting device 600 includes multiple light sources 620A and 620B, a paraboloidal enclosure element 610, and a ball lens 660. The light 630A and 630B emitted from the light sources 620A and 620B parallel to the axis 611 of the paraboloid partially passes through the enclosure element 610 and partially reflects off the enclosure element 610. The partially reflected light 640A and 640B intersects at the focus 650 of the paraboloid due to the nature of a paraboloid. The light intersecting at the other focus 650 becomes a virtual light source.

When a ball lens 660 is placed over the light source 620B, it collects and redirects all light 670A and 670B from the light source 620B toward the direction that is parallel to the axis 611 of the paraboloid, as illustrated by the light 680A and 680B. As a result, additional reflected light 690A and 690B intersects at the focus 650 of the paraboloid, with the net effect of increasing the intensity of the light of the virtual light source at the focus 650.

FIG. 7 illustrates another embodiment of the present invention. The lighting device 700 includes multiple light sources 720A and 720B, a paraboloidal enclosure element 710, and a paraboloidal reflector 760. The light 730A and 730B emitted from the light sources 720A and 720B parallel to the axis 711 of the paraboloid partially passes through the enclosure element 710 and partially reflects off the enclosure element 710. The partially reflected light 740A and 740B intersects at the focus 750 of the paraboloid due to the nature of a paraboloid. The light intersecting at the other focus 750 becomes a virtual light source.

The light 770A and 770B emitted from the light source 720B in the direction away from the focus 750 is collected and redirected by the paraboloidal reflector 760 toward the direction that is parallel to the axis 711 of the paraboloid enclosure element, as illustrated by the light 780A and 780B. As a result, additional reflected light 790A and 790B intersects at the focus 750 of the paraboloid enclosure element, with the net effect of increasing the intensity of the light of the virtual light source at the focus 750.

While the invention has been described and illustrated in its preferred embodiments, it should be understood that departure therefrom may be made within the scope of the invention, which is not limited to the specific details disclosed herein. Furthermore, it should be understood that the features of illustrated embodiments can be combined in any way, form, or fashion, to create another embodiment.

What is claimed is:

1. A lighting device comprising: at least one light source and an enclosure element enclosing the at least one light source wherein a portion of the enclosure element has a focus-forming curvature such that light from the at least one light source and then reflected off the focus-forming curvature of the enclosure element intersects at or in a proximate region around a focus of the focus-forming curvature and creates a virtual light source at the focus.

2. The lighting device as claimed in claim 1, wherein the portion of the enclosure element having the focus-forming curvature is a part or all of an ellipsoid and the at least one light source is positioned at or adjacent to one of the two focuses of the ellipsoid, such that the light from the at least one light source and then reflected off the focus-forming curvature of the enclosure element intersects at or in a proximate region around the other focus of the ellipsoid.

3. The lighting device as claimed in claim 1, wherein the portion of the enclosure element having the focus-forming curvature is a part of a paraboloid, and the at least one light source is positioned in the open end of the paraboloid.

4. The lighting device as claimed in claim 1, wherein an optical lens is placed between the at least one light source and the focus of the focus-forming curvature of the enclosure element such that the optical lens changes the direction of the light from the at least one light source and subsequently changes the shape or size of the proximate region around the focus wherein the light reflected off the focus-forming curvature intersects.

5. The lighting device as claimed in claim 4, wherein the optical lens is a diffuser lens such that the proximate region around the focus is expanded toward the at least one light source.

6. The lighting device as claimed in claim 4, wherein a reflective means is applied on the portion of the enclosure element having the focus-forming curvature for increasing the intensity of light reflected off the focus-forming curvature of the enclosure element and subsequently increasing the intensity of light intersecting at or in the proximate region around the focus.

7. The lighting device as claimed in claim 6, wherein a reflective means is placed at or adjacent to the focus of the focus-forming curvature of the enclosure element to redirect the reflected light that intersects at or in a proximate region around the focus.

8. The lighting device as claimed in claim 1, wherein a reflective means is applied on the portion of the enclosure element having the focus-forming curvature for increasing the intensity of light reflected off the focus-forming curvature of the enclosure element and subsequently increasing the intensity of light intersecting at or adjacent to the focus.

9. The lighting device as claimed in claim 8, wherein the reflective means is a reflective coating.

10. The lighting device as claimed in claim 8, wherein the reflective means is implemented by forming the portion of the enclosure element having the focus-forming curvature with a reflective material.

11. The lighting device as claimed in claim 8, wherein the reflective means is implemented by placing a curved mirror adjacent to the focus-forming curvature.

12. The lighting device as claimed in claim 1, wherein a reflective means is placed at or adjacent to the focus of the focus-forming curvature of the enclosure element to redirect the reflected light that intersects at or in a proximate region around the focus.

13. The lighting device as claimed in claim 12, wherein the reflective means is a mirror ball.

14. The lighting device as claimed in claim 12, wherein the reflective means is a reflector of a particular shape and pattern so as to create a non-uniform reflecting effect.

15. The lighting device as claimed in claim 1, wherein a light collecting means is placed between the at least one light source and the enclosure element such that the light from the at least one light source is collected by the light collecting means and redirected toward the focus-forming curvature of the enclosure element.

16. The lighting device as claimed in claim 15, wherein the light collecting means is a ball lens overlaying the at least one light source and the portion of the enclosure element having the focus-forming curvature is a part of a paraboloid.

17. The lighting device as claimed in claim 15, wherein the light collecting means is a paraboloidal reflector placed behind the at least one light source.
